(19) United States
(12) Patent Application Publication
(10) Pub. No.: US 2014/0074672 A1
(43) Pub. Date: Mar. 13, 2014

(54) Fraud tracking network

(71) Applicant: Michael Sarver, Covington, LA (US)

(72) Inventor: Michael Sarver, Covington, LA (US)

(21) Appl. No.: 13/573,300

(22) Filed: Sep. 10, 2012

(51) Int. Cl. G06Q 50/26; G06Q 40/00

(52) U.S. Cl. CPC G06Q 50/26; G06Q 40/103
USPC 705/31

(57) ABSTRACT

A tax fraud finder network is provided with a device for calculating a score based on information provided to government agencies by using multiple collections of information. An HEV algorithm uses mismatches in different sets of collections to arrive at a display and edit score. A report is generated and sent to local government agencies to find violations.

### BACKGROUND OF THE INVENTION

Many states provide a Homestead Exemption Act which provides benefits to the home owner, or the spouse in the event of the home owner's death. The benefits may differ from state to state, and include but are not limited to:
Property Tax Exemption,
Prevention of forced sale, and/or
Residence for the widow of a homeowner.

However, many people who participate in the Homestead Exemption program forget to withdraw after becoming ineligible, thereby withholding revenue to the government. Although there are measures in place to assess and update the status of a Homestead Exemption, these measures require many hours, combing through public records, and must be conducted annually. In addition, human error is unavoidable.

Businesses throughout the world use databases to keep track of records for payroll, contacting customers, collections, tracking employee expenditures, act. Federal and State Government use databases in many ways to collect taxes and monitor taxpayers for payment of taxes based on their reports from business. Unfortunately, not all taxpayers can be monitored for status changes.

### FIELD OF THE INVENTION

The present invention is an investigative tool designed to automatically validate individual homestead exemptions

The present invention is a business-to-public-administration tool designed to annually confirm the accuracy of the existing homestead exemptions filed for residential properties throughout individual parishes in Louisiana. The purpose of the present invention is to capture all legitimate tax revenue for municipalities by confirming all existing homestead exemptions are correct.

### SUMMARY OF THE INVENTION

A method and computing network for tracking a user of an exemption law is providing in order to locate violations of the act designed to exempt residents from paying taxes on real estate.

It is another object of the present invention to provide an operational computing network having means for calculating a score for each user based on address miss matches.

It is another object of the present invention to provide an operational computing network for tracking a registered user and means for calculating a score for each user based on license expiration dates.

It is yet an object of the present invention to provide an operational computing network for tracking a registered user and means for calculating a score for each user based on last voted dates tax payment dates.

It is still another object of the present invention to provide an operational computing network for tracking a registered user and means for calculating a score for each user based on voter registration addresses.

It is another object of the present invention to provide an operational computing network for tracking a registered user and means for sending a report after calculating scores of Homestead Act violators.

It is another object of the present invention to provide an operational computing network for tracking and monitoring a registered user for Homestead Act violations.

Finally, an object of the present invention is to provide an operational computing network for tracking a registered user and having means for providing a searchable display for mismatches of addresses of registered Homestead Act participants.

Individuals who register for exemption from real estate taxes are monitored by an operational computing network for duplicate addresses on a variety of different databases. Those registered users are analyzed and a score is calculated based on a number of tests on different databases. Violations are detected and a report is provided to a local government computer for assessment.

### DETAILED DESCRIPTION OF THE DRAWINGS

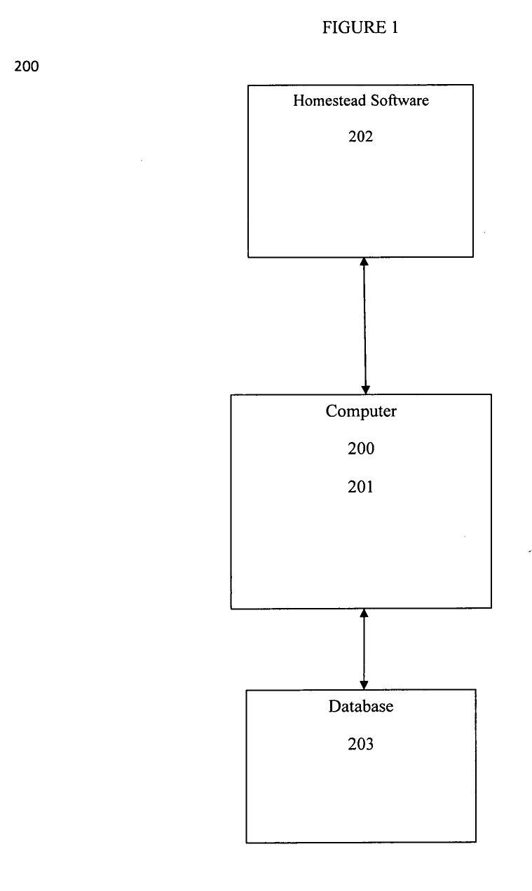

FIG. 1 is a schematic illustration of a tax fraud finder network.

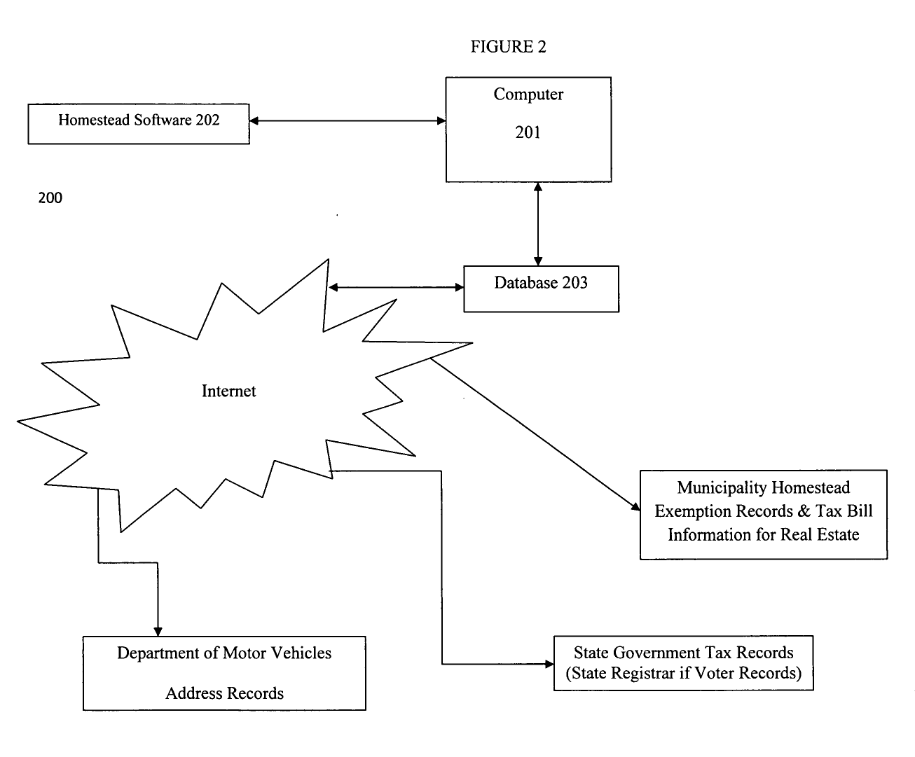

FIG. 2 is a schematic illustration of an Internet tax fraud finder network.

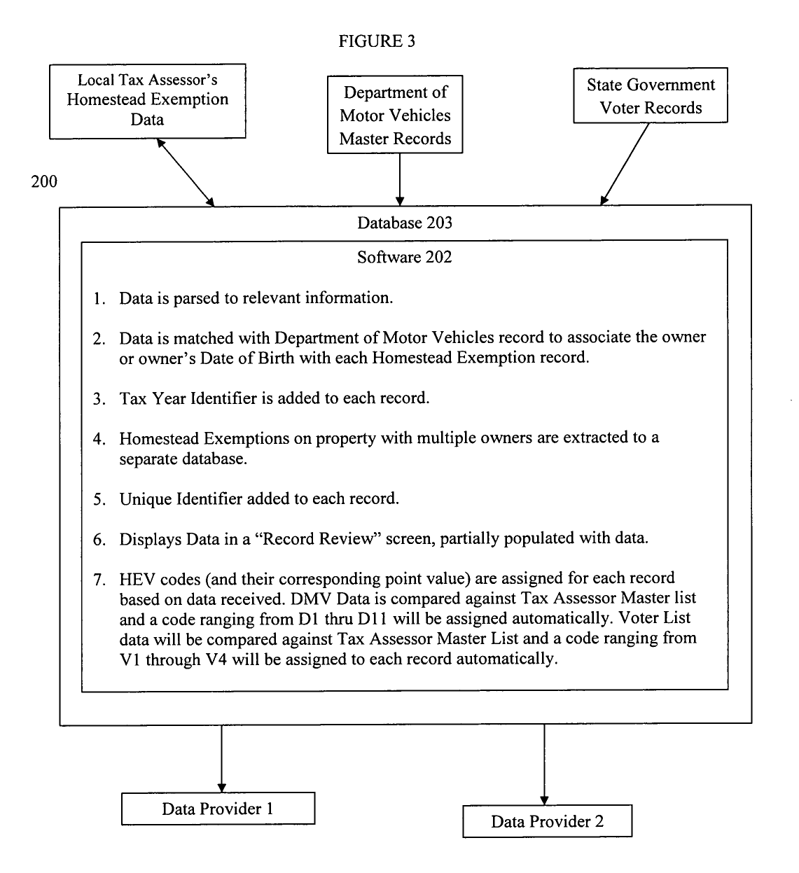

FIG. 3 is a schematic illustration of a discovery section for a tax fraud finder network.

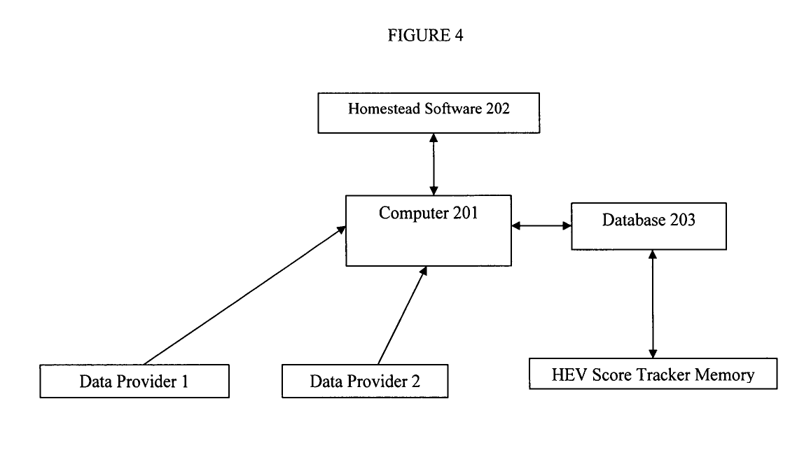

FIG. 4 is a schematic illustration of a flow chart section of a tax fraud finder network.

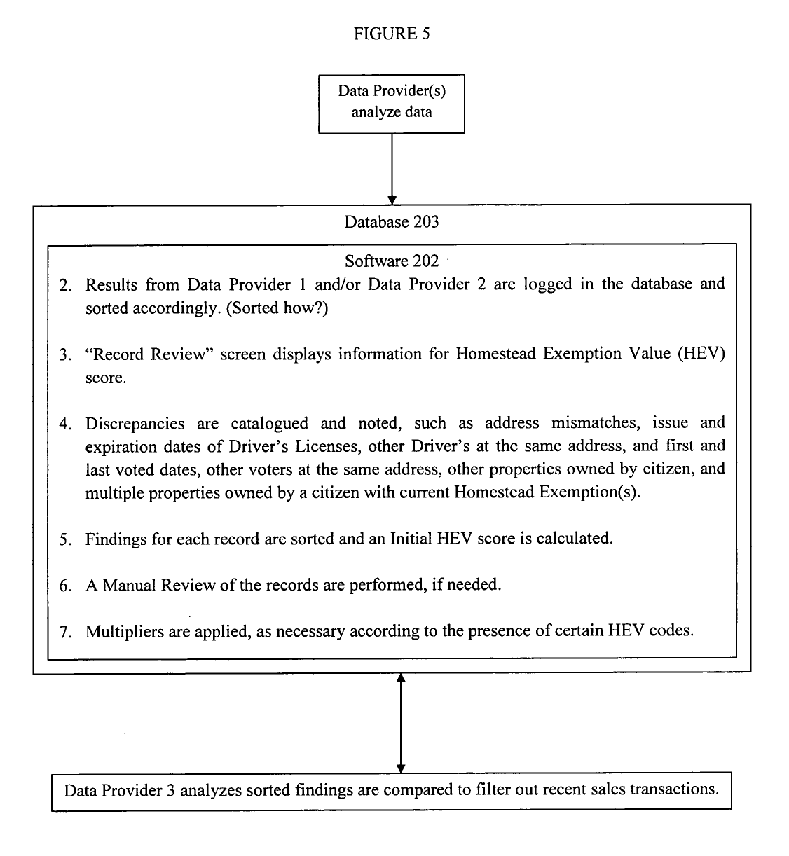

FIG. 5 is a schematic illustration of a data section of a tax fraud finder network.

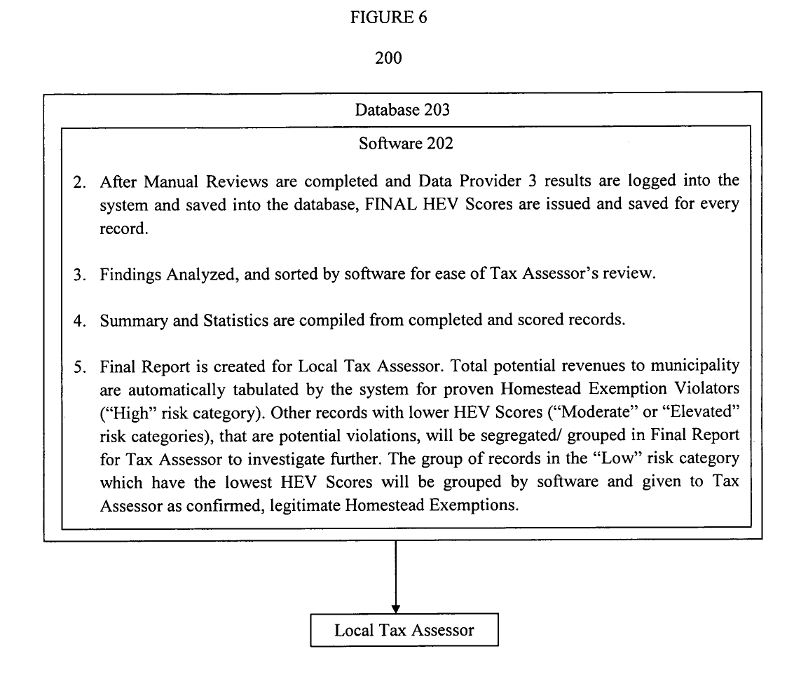

FIG. 6 is a schematic illustration of an analysis section tax fraud finder network.

### DETAILED DESCRIPTION OF THE PREFERRED EMBODIMENT

A method and apparatus for tracking registered users and detecting tax fraud is provided using a variety of databases. The preferred embodiment of the present invention includes an algorithm to calculate a score for each user based on address mismatches, license expiration dates, last voted dates and tax payment dates, means for preparing a report based on said score and mailing said report to a local tax Assessor.

As illustrated in FIG. 1, an operational computing network 200 for tracking a user of an exemption law is shown. The operational computing network 200 includes a provider microprocessor 201, a homestead software program 202, a provider database 203 and a provider display screen 204 which are connected to the internet for receiving and sending information to and from various local governments and social network providers. Each registered user is provided with a user identification code which permits the operational computing network to track the registered user throughout different databases, such as a voter registration database, a department of motor vehicles database or partnered databases sold by social networks such as those provided by Lexis or Thomson. As each registered user is check for duplicate or mismatch addresses a score is calculated based on the number of conflicting addresses. The provider display screen 204 permits a provider with a visual of the results of a number of registered users as the scores are reported and displayed. As each list of addresses on the providers database is compared to the list of addresses on other databases the display provides the information and gives an updated score

FIG. 2 discloses a validation monitor which calculates a validation score for the network. The validation score provides the local government with an easy way to compute the amount of back taxes owed based on the date the fraud occurred, the number of days and the amount of money owed based on the days delinquent and interest penalty. An office fee may also be charged to pay for the use of the network.

### Major Benefits:

Assessor doesn't need to hire additional full-time employees to try and research the accuracy of every homestead exempt property, each and every year.
Automatically lists all potential homestead exemption violations yearly and reports those questionable addresses to the assessor.
Administrative keystroke errors are discovered each year for properties that should not have received a homestead exemption, but may have by accident.
Average homestead exemption is about $800 to $1,200 depending upon location. Therefore for every 1000 erroneous exemptions that are nullified, the revenue gained for the municipality (that would have normally gone uncollected) would be about $1M.

A tax fraud finder network is provided with a device for calculating a score based on information provided to government agencies by using multiple collections of information. An HEV algorithm uses mismatches in different sets of collections to arrive at a display and edit score. A report is generated and sent to local government agencies to find violations.

### HEV Score

The HEV Score is a numerical figure that quantifies the risk that a particular citizen does not live in the home that s/he is purported to live in as their primary residence. HEV Scores are derived by adding together various, proven factors that are associated with each record (after thorough research is completed form a variety of sources). Using the latest technology in “skip-tracing” and/or using methods to find people in addition to researching property records—all on a large scale, Assessure Systems has developed a way to measure all the diverse factors related to home ownership, residency and tax collection. Once all of the factors are obtained, a numerical value is placed on each type, then they are added together to represent the risk associated with someone living at a particular address (or not). Scores will range from 0 to above 30. The lower the HEV Score, the higher the likelihood that the citizen does in fact, live in a different property than the one reported to a Tax Assessor as their primary residence. It is in this case that any tax benefit or deduction, such as the Homestead Exemption, given to such citizen should therefore be removed by the Tax Assessor.

HEV Scores will be given to every record and there will be four distinct classifications for Final HEV Scores:
LOW Risk,
MODERATE Risk,
ELEVATED Risk an
HIGH Risk.

### Process

### Step One:

Local Tax Assessor is sold on concept of pro-actively monitoring Homestead Exemptions. Contingency based contract is drawn up based on amount of tax revenue gained from the present invention. Assessor gives authorization for my company to act as its Agent, in order to be able to access DMV records.

### Step Two:

Tax Assessor provides list of every Homestead Exemption granted in parish to me in .csv file (or similar format). This is the Master List.

### Step Three:

The list provided by the Tax Assessor is immediately uploaded to our website, time-stamped, and prepared for electronic delivery to a Data Provider. Other attributes are automatically logged such as total number of records, number of records with full or partial homestead exemption, number of records with married owners, single owners, and multiple owners, for subsequent statistical analysis.

### Step Four:

List is uploaded to a Data Provider for analysis and time-stamped. Data Provider processes custom report using a cross section of databases and public records indicating which citizens with a current Homestead Exemption have:

A. died, with date of death;

B. a better, more current address in another location and effective date;

C. a bona fide current Homestead Exemption on another property; and/or

D. have multiple properties (with other addresses listed).

Factors A, B and D are possible indicators that current Homestead Exemption is not legitimate. Of course, names flagged under section C are confirmed cases where another current Homestead Exemption exists. Names and addresses under these four sections are flagged by computer automatically. As performed in step three, other attributes are automatically logged such as total number of records, number of records with full or partial homestead exemption, number of records with married owner, single owners, and multiple owners for subsequent statistical analysis. All processed records from this list are added to a Master Database.

### Step Five:

Most recent DMV report is obtained from Office of Motor Vehicles which will include name, address, date of birth, issue and expiration date for licensed drivers eighteen years of age or more, plus identification cards for citizens eighteen years of age or more. This information is transmitted via secure FTP connection and retained in a separate Master Database.

### Step Six:

Name, address and date of birth will be automatically compared by system against original list from Tax Assessor to be certain names and addresses match. Comparison of identification issue date with tax year will be automatically factored in as well. Mismatches are flagged automatically by website.

Example: Billy Bob Jones has current unexpired drivers license issued three years ago at 123 Main Street, Covington, La. But the list from assessor says he lives at 456 Oak Street and has a Homestead Exemption there currently.

Louisiana State Law requires Driver's Licenses be updated within ten days of an address change. Not everyone complies, but flagging this record will be a helpful tool.

The software automatically expands the Master List and prepares to transmit to Data Provider 1 and Data Provider 2. The software “expands” the list into an “Expanded Homeowner” format by dropping extra data fields, matching against Department of Motor Vehicle records to add Date of Birth to each record, adding the tax year, separating multiple owners, and issuing a unique identifier. A “Record Review” screen is populated with all available information from the “Expanded Homeowner” List to verify the information added and matched.

### Step Seven:

Latest voter roll/registration is obtained from Secretary of State for all registered voters in parish via e-mail attachment. Names, addresses and DOB's are compared to original list from Tax Assessor. Mismatches are flagged automatically by website. The system issues a V1 through V4 designation. This designation indicates the status of the Registered Voter and their associated address.

Example: Same name at different address than assessor list, or different name at same address.

Not all citizens vote and not all citizens keep their address up to date for voter registration so this is only a helpful tool, not necessarily proof in and of itself. Steps 5, 6 and 7 will happen simultaneously.

### Step Eight:

Processed lists from Step 4, Step 6 and Step 7 are then automatically compared against each other by computer system and all flagged properties are automatically analyzed and listed as potential Homestead Exemption violators using a Confidence Scoring System.

### Example:

If citizen is shown to have:

1) Another property with Homestead Exemption (see Step 4C above);

2) DMV data flags showing the address listed in Step 4C; and

3) Voter Rolls show the same address as in Step 4C;

Then the Confidence Score would be very high that this citizen is in violation and should have Homestead Exemption removed by Tax Assessor. System would automatically add this record to the “Homestead Exemption Removal” list.

Conversely, if the only flag for particular citizens was for voter roll information, DMV data is consistent with original Tax Assessor list, and Data Provider shows no flag for other properties or better addresses, then a low Confidence Score is assigned automatically to this record and it is not suggested to remove Homestead Exemption. It would be added to “Homestead Exemption Valid” list.

For records that indicate mid-range Confidence Scores, then there may be one or more flags in various combinations, but data is inconclusive without further manual review. Summary report is automatically issued and record is left in manual review status. Manual review would require individual scrutiny which would include other internet searches, possible mailings, data acquisition from local utility companies and other methods for determining whether record is valid or needs Homestead Exemption removed. After manual review is complete, Confidence Score is recalculated and record is added to either the “Homestead Exemption Valid” or “Homestead Exemption Removal” lists.

At this point, findings for each record are sorted and all codes have been assigned to each record according to the information received (DMV, Voter, Data Provider 1 and or Data Provider 2). Software calculates initial HEV scores for every record by adding the individual point values for each code together.

For example, a fully processed record may contain the following HEV Codes: L1, L4, D3, D10 and V1. Therefore, the formula would equate to:

L1+L4+D3+D10+V1=Initial HEV Score.

The software automatically replaces the HEV Codes with their numerical equivalent and the formula looks like this: (0+7+7+10+2=26) Therefore, 26 is the Initial HEV Score.

### HEV Code Values

The following codes are used by software and assigned to each record based on information obtained from the various sources. Each code has a numerical point value and after all data is received, the software adds up the combined HEV Value of all the Codes in addition to any possible Multipliers that apply. An initial HEV Score is issued for every record. After completion of any Manual Reviews or record omissions due to prior year property sales obtained from Data Provider 3, a Final HEV Score is issued by software and included in Final Report to Tax Assessor.

Data Provider 1 & 2
L1 through L10 designations

| Output File | | | |
|---|---|---|---|
| Value | Status | Code | HEV |
| 1) Death: | NO | L1 | 0 |
| | Yes >1 yr | L2 | 25 |
| | Yes <1 yr | L3 | 20 |
| 2) Best Address: (If different than initial | | L4 | 7 |
| HE list) | | | |
| 3) HE Indicator: (Indicates another HE is in | | L5 | 10 |
| place somewhere else) | | | |
| 4) Other Properties: Where at least one | | L6 | 6 |
| property address matches [unexpired] | | | |
| DMV Drivers License/ID address | | | |
| Where at least one property address matches | | L7 | 4 |
| [expired] DMV Drivers License/ID address | | | |
| Where NO addresses match DMV Drivers | | L8 | 2 |
| License/ID address | | | |
| 5) NO Hits/Rejects: | | L9 | 2 |
| 6) Subject Address Confirmed: (Address | | L10 | 0 |
| has been confirmed to match input | | | |
| address on HE Master List) | | | |

DMV D1 through D11 designations

| File | | | |
|---|---|---|---|
| Value | Status | Code | HEV |
| 1) Driver and address confirmed at SAME | [Unexpired Driver's License] | D1 | 0 |
| address as HE Master List | [Expired Driver's License] | D2 | 2 |
| 2) Driver confirmed at DIFFERENT | [Unexpired Driver's License] | D3 | 7 |
| address than HE Master List | [Expired Driver's License] | D4 | 4 |
| (and different than L4, L5 addresses) | | | |
| 3) Citizen and address confirmed at SAME | [Unexpired ID CARD] | D5 | 0 |
| address as HE Master List | [Expired ID CARD] | D6 | 2 |
| 4) Citizen confirmed at DIFFERENT | [Unexpired ID CARD] | D7 | 7 |
| address than HE List | [Expired ID CARD] | D8 | 4 |
| 5) NO Driver's License or ID Card for citizen | | D9 | 5 |
| 6) Driver and/or ID confirmed at DIFFERENT | [Unexpired] | D10 | 10 |
| Address than HE Master List, but SAME | [Expired] | D11 | 8 |
| address as address found for L4 or L5 | | | |

Voter Registration Information V1 through V4

| File | | |
|---|---|---|
| Value | Code | HEV |
| 1) NOT on the list as Registered Voter | V1 | 2 |
| 2) Confirmed Registered Voter at SAME | V2 | 0 |
| Address as HE Master List | | |
| 3) Confirmed Registered Voter at | V3 | 5 |
| DIFFERENT Address than HE Master List | | |
| 4) Confirmed Registered Voter at | V4 | 10 |
| DIFFERENT Address than HE Master List | | |
| AND SAME as L4, L5, L6, L7 or L8 | | |

### HEV Multipliers

L4—“Best Address” Multipliers

If these factors are present for the record, an Additional Value must be added to Initial HEV Score. This multiplier effect equates to a higher “confidence” level since many disparate data sources are confirming the same thing (i.e.: confirmed data that may be contradictory to Tax Assessors current information).

| Multiplier Codes: | Value Added to Initial HEV Score |
|---|---|
| L1 + L4 + D4 + V1 = | 4 |
| L1 + L4 + D4 + V3 = | 4 |
| L1 + L4 + D4 + V3 + V4 = | 10 |
| L1 + L4 + D8 + V1 = | 4 |
| L1 + L4 + D8 + V3 = | 4 |
| L1 + L4 + D8 + V3 + V4 = | 10 |
| L1 + L4 + D9 + V1 = | 10 |
| L1 + L4 + D9 + V3 = | 4 |
| L1 + L4 + D9 + V3 + V4 = | 10 |

### L5—“HE Indicator” Multipliers

If these factors are present for the record, an Additional Value must be added to Initial HEV Score. This multiplier effect equates to a higher “confidence” level since many disparate data sources are confirming the same thing (i.e.: confirmed data that may be contradictory to Tax Assessors current information).

| Multiplier Codes: | Value Added to Initial HEV Score |
|---|---|
| L1 + L5 + D4 + V1 = | 5 |
| L1 + L5 + D4 + V3 = | 4 |
| L1 + L5 + D4 + V3 + V4 = | 10 |
| L1 + L5 + D8 + V1 = | 4 |
| L1 + L5 + D8 + V3 = | 4 |
| L1 + L5 + D8 + V3 + V4 = | 10 |
| L1 + L5 + D9 + V1 = | 10 |
| L1 + L5 + D9 + V3 = | 4 |
| L1 + L5 + D9 + V3 + V4 = | 10 |

### L6—“Other Properties” Multipliers

If these factors are present for the record, an Additional Value must be added to Initial HEV Score. This multiplier effect equates to a higher “confidence” level since many disparate data sources are confirming the same thing (i.e.: confirmed data that may be contradictory to Tax Assessors current information).

| Multiplier Codes: | Value Added to Initial HEV Score |
|---|---|
| L1 + L6 + D3 + V1 = | 3 |
| L1 + L6 + D3 + V3 = | 4 |
| L1 + L6 + D3 + V3 + V4 = | 10 |
| L1 + L6 + D7 + V1 = | 3 |
| L1 + L6 + D7 + V3 = | 4 |
| L1 + L6 + D7 + V3 + V4 = | 10 |

### L7—“Other Properties” Multipliers

If these factors are present for the record, an Additional Value must be added to Initial HEV Score. This multiplier effect equates to a higher “confidence” level since many disparate data sources are confirming the same thing (i.e.: confirmed data that may be contradictory to Tax Assessors current information).

| Multiplier Codes: | Value Added to Initial HEV Score |
|---|---|
| L1 + L7 + D4 + V1 = | 3 |
| L1 + L7 + D4 + V3 = | 4 |
| L1 + L7 + D4 + V3 + V4 = | 10 |
| L1 + L7 + D8 + V1 = | 3 |
| L1 + L7 + D8 + V3 = | 4 |
| L1 + L7 + D8 + V3 + V4 = | 10 |

### L8—“Other Properties” Multipliers

If these factors are present for the record, an Additional Value must be added to Initial HEV Score. This multiplier effect equates to a higher “confidence” level since many disparate data sources are confirming the same thing (i.e.: confirmed data that may be contradictory to Tax Assessors current information).

| Multiplier Codes: | Value Added to Initial HEV Score |
|---|---|
| L1 + L8 + D3 + V1 = | 4 |
| L1 + L8 + D3 + V3 = | 4 |
| L1 + L8 + D3 + V3 + V4 = | 7 |
| L1 + L8 + D4 + V1 = | 4 |
| L1 + L8 + D4 + V3 = | 4 |
| L1 + L8 + D4 + V3 + V4 = | 7 |
| L1 + L8 + D7 + V1 = | 4 |
| L1 + L8 + D7 + V3 = | 4 |
| L1 + L8 + D7 + V3 + V4 = | 7 |
| L1 + L8 + D8 + V1 = | 4 |
| L1 + L8 + D8 + V3 = | 4 |
| L1 + L8 + D8 + V3 + V4 = | 7 |
| L1 + L8 + D9 + V1 = | 6 |
| L1 + L8 + D9 + V3 = | 4 |
| L1 + L8 + D9 + V3 + V4 = | 8 |

### L9—“No Hits/Rejects” Multipliers

If these factors are present for the record, an Additional Value must be added to Initial HEV Score. This multiplier effect equates to a higher “confidence” level since many disparate data sources are confirming the same thing (i.e.: confirmed data that may be contradictory to Tax Assessors current information).

| Multiplier Codes: | Value Added to Initial HEV Score |
|---|---|
| L1 + L9 + D3 + V1 = | 4 |
| L1 + L9 + D3 + V3 = | 4 |
| L1 + L9 + D4 + V1 = | 4 |
| L1 + L9 + D4 + V3 = | 4 |
| L1 + L9 + D7 + V1 = | 4 |
| L1 + L9 + D7 + V3 = | 4 |
| L1 + L9 + D8 + V1 = | 4 |
| L1 + L9 + D8 + V3 = | 4 |
| L1 + L9 + D9 + V1 = | 6 |
| L1 + L9 + D9 + V3 = | 4 |

### L10—“Subject Address Confirmed” Multiplier

If these factors are present for the record, an Additional Value must be added to Initial HEV Score. This multiplier effect equates to a higher “confidence” level since many disparate data sources are confirming the same thing (i.e.: confirmed data that may be contradictory to Tax Assessors current information).

| Multiplier Codes: | Value Added to Initial HEV Score |
|---|---|
| L1 + L10 + D3 + V1 = | 4 |
| L1 + L10 + D3 + V3 = | 6 |
| L1 + L10 + D4 + V1 = | 4 |
| L1 + L10 + D4 + V3 = | 6 |
| L1 + L10 + D7 + V1 = | 4 |
| L1 + L10 + D7 + V3 = | 6 |
| L1 + L10 + D8 + V1 = | 4 |
| L1 + L10 + D8 + V3 = | 6 |
| L1 + L10 + D9 + V1 = | 6 |
| L1 + L10 + D9 + V3 = | 4 |

Manual Reviews are performed based on the HEV Code Values in order to complete or correct record data. Manual reviews are required for the following reasons:
Any deceased citizens (L2 or L3 HEV Code);
Driver's License issue dates less than 6 months old;
Initial HEV Scores that range from 15-24;
Address mismatches between the Department of Motor Vehicles and Tax Assessor List;
No hit records with HEV Score 20 or higher (L9 designation) or combined factors L9+D9+V1; and
For all L9 and L10 records IF D3/D7 address is the same as V3.

Multipliers are point values applied to the formula on top of normal HEV Code values. Multipliers exist only when certain HEV Codes are present. They are described in Exhibit B, “HEV Multipliers.”

Factors that affect the determination of the FINAL HEV Score are data received after a Manual Review is performed and built-in multipliers are applied for certain combinations of factors.

### Step Nine:

After all lists are processed and reviewed for accuracy, they are tabulated and final report issued to Tax Assessor giving statistical analysis and final numbers on “Homestead Exemption Removal” list data. Additional tax revenue raised by the present invention is clearly marked. Tax Assessor has individual report for each citizen/property so mailer can be sent to citizen to identify why Homestead Exemption is being removed. Final report will be date-stamped in system for future statistical comparisons with other parishes or future reports for same parish. Master Database will be retained for future use.

Each Tax Assessor will approach the verification process differently for the different Risk classifications assigned by the software. Tax Assessors may decide to pursue “Elevated” risk records more aggressively, while not pursuing “Moderate” and “Low” risk records at all. Or, he or she may decide to pursue “Moderate” and “Elevated” records in the same fashion. It will be up to each Tax Assessor to decide which method is best for them. Also, it will be up to each Tax Assessor to decide whether or not to include Assessure Systems in the collection/verification process above and beyond the service described at this point.

### Step Ten:

Payment for services, per contract, will be made by Parish to Assessure

Systems, LLC upon next billing cycle for real estate tax collections, except for possibly Orleans Parish, as they are billed in advance rather than in arrears. This is open to negotiation, of course.

A provider will seek to earn payment from each municipality on a contingency basis. Each provider will earn a portion of all revenues raised from utilizing this service to find otherwise unknown homestead exemption violations (past and present). By removing the exemption from the ineligible citizen, the full tax value will be collected during the next tax billing cycle (prior tax years+penalties+interest can be collected as well and providers will list which records this applies to) and a provider will earn a portion of this additional revenue. The timing and mechanism used to pay a provider will be defined by contractual agreement specific to each municipality and in accordance with all state and local laws/regulations.

Another possible service not mentioned above, to be provided by a provider, deals with partial Homestead Exemptions. Title attorneys used to prepare ownership documents for citizens wherein the owner-occupant would own at least 1% of the property, while other owners on title would own the majority of the property. One example of this is where some people intentionally skirted or stretched the law by purchasing multiple properties. The parents would own multiple properties with full Homestead Exemptions while the children, whose name the Assessor was using for granting the full Homestead Exemption, owned just a 1% stake in each of the properties. Since an owner occupied the property as the children's primary residence, albeit with only 1% ownership, the assessors would still issue a 100% Homestead Exemption for that record. That has since changed, and assessors now pro-rate the Homestead Exemption based on the percentage of ownership of the stated owner-occupant.

However; there are hundreds, possibly thousands of citizens from the past in each parish who are still receiving the 100% Homestead Exemption, when they may legally own as little as just 1% of the property. Right now, we have developed a way to check these records and show what the actual percentage ownership is of the current owner-occupant. Together with the above service, we can confirm whether the stated owner-occupant does live there, and what ownership percentage they have. Therefore, we can have the Homestead Exemption adjusted to reflect their current ownership percentage, whether it is 1%, 10% or 20%. Given the average full Homestead Exemption saves a resident about $1,000 in Parish real estate taxes, correcting a few hundred of these erroneous Homestead Exemptions would raise significant revenue for the parish. At present, this would be done manually, record by record, until an automated process could be developed.

In conducting a process for locating possible fraudulent violations of the Homestead Act, a list of names and addresses are provided from a Homestead Act local database. The list is then provided through the internet to a provider database which is connected to a provider microprocessor. The provider database includes names and address of all individuals listed in the database from the Department of Motor Vehicles. The provider microprocessor has Homestead Act finder software.

The Homestead Act finder software expands the information provided from the local jurisdiction by dropping local data fields, adds the date of birth to all individuals on record, adds the current tax year, separates multiple owners, provides a unique identifier to each individual listed and a record review screen is created with all the information currently in the provider database. The expanded list is then run against all databases sent to the data providers.

The method further provides the steps of comparing the expanded homeowner list with a DMV Master list from the state. The results are logged into the system and displayed on a DMV record review screen for an HEV score. The HEV Score is calculated using address mismatches, issue/expiration dates and other drivers with the same addresses. In conclusion, the system issues a D1-D11 designation.

A second step compares the homeowner list with the voter registration database. The results are logged into the system and displayed on a VR record and review screen and compared with VR Records on the database for addresses and last voted dates. A score of V1-V4 is calculated and destined for final calculation.

In a third step, submits lists to DP1 (a first social network) The results are logged into the system and displayed on a HEV record review screen for an HEV score. The HEY Score is calculated using calculations. In conclusion, the system issues a L1-L10 designation.

In a fourth step, submits lists to DP (a second social network) The results are logged into the system and displayed on a HEV record review screen for an HEV score. The HEV Score is calculated using calculations. In conclusion, the system issues a L1-L10 designation.

The fifth step the findings are sent to a filtering server to filter out recent sales transactions. The system then recalculates Final HEV score manually reviewing all HEV scores. The findings are then analyzed and a final report is created giving each identified individual a score. The report is sent to the local Tax Assessor.

As illustrated in FIG. 3, an operational computing network 200 for tracking a user of an exemption law is shown. The operational computing network 200 includes a provider microprocessor 201, a homestead software program 202, a provider database 203 and a provider display screen 204 which are connected to the internet for receiving and sending information to and from various local governments and social network providers. Each registered user is provided with a user identification code which permits the operational computing network to track the registered user throughout different databases, such as a voter registration database, a department of motor vehicles database or partnered databases sold by social networks such as those provided by Lexis or Thomson. As each registered user is check for duplicate or mismatch addresses a score is calculated based on the number of conflicting addresses. The provider display screen 204 permits a provider with a visual of the results of a number of registered users as the scores are reported and displayed. As each list of addresses on the provider's database is compared to the list of addresses on other databases the display provides the information and gives an updated score. In any of the preferred embodiments of the apparatus of the invention, the means for performing the given function comprises a computer, computer system, computer software, an algorithm, or combination thereof, and optionally comprises a means for graphic display, for example, a computer monitor or a printer; and internet communication. The preferred embodiments optionally comprise at least one database which contains, for example, real estate tax data, drivers license data, federal income tax data, homestead exemption data, voter registration data, utilities data bank account data.

A portion of the disclosure of this patent document contains material that is subject to copyright protection and to which a claim of copyright protection is made. The owner has no objection to the facsimile reproduction by anyone of the patent disclosure, as it appears in the Patent and Trademark Office patent files or records, but otherwise reserves all copyright rights whatsoever

1. An operational computing network for tracking a user of an exemption law, said operational computing network comprising:
a provider microprocessor;
a homestead software program provided with an algorithm;
a provider database;
a provider display screen;
a voter registration database;
a department of motor vehicles database;
a user identifier code;
means for calculating a score for each user based on address mismatches, license expiration dates, last voted dates and tax payment dates; and
means for preparing a report based on said score and mailing said report to a local tax Assessor.

2. An operational computing network for tracking a user of an exemption law as recited in claim 2, said operational computing network comprising:
said provider display screen displaying results of comparing a list of individual addresses on said provider database with said voter registration database.

3. An operational computing network for tracking a user of an exemption law as recited in claim 2, said operational computing network comprising:
said provider display screen displaying results of comparing a list of individual addresses on said provider database with said motor vehicles database.

4. An operational computing network for tracking a user of an exemption law as recited in claim 7, said operational computing network comprising:
said provider display screen displaying results of comparing a list of individual addresses on said provider database with a real estate tax database.

5. An operational computing network for tracking a user of an exemption law as recited in claim 7, said operational computing network comprising:
said provider display screen displaying results of comparing a list of individual addresses on said provider database with Federal Income Tax database.

6. An operational computing network for tracking a user of an exemption law as recited in claim 7, said operational computing network comprising:
said provider display screen displaying results of comparing a list of individual addresses on said provider database with license plate database.

7. An operational computing network for tracking a user of an exemption law, said operational computing network comprising:
a provider microprocessor;
a homestead software program provided with an algorithm;
a provider database;
a provider display screen;
a voter registration database;
a department of motor vehicles database;
a user identifier code;
means for calculating a score for each user based on address mismatches, license expiration dates, last voted dates and tax payment dates; and
means for preparing a report based on said score and mailing said report to a local tax Assessor.

8. An operational computing network for tracking a user of an exemption law as recited in claim 1, said operational computing network comprising:
said provider display screen displaying results of comparing a list of individual addresses on said provider database with said voter registration database.

9. An operational computing network for tracking a user of an exemption law as recited in claim 1, said operational computing network comprising:
said provider display screen displaying results of comparing a list of individual addresses on said provider database with said motor vehicles database.

10. An operational computing network for tracking a user of an exemption law as recited in claim 1, said operational computing network comprising:
said provider display screen displaying results of comparing a list of individual addresses on said provider database with a real estate tax database.

11. An operational computing network for tracking a user of an exemption law as recited in claim 7, said operational computing network comprising:
said provider display screen displaying results of comparing a list of individual addresses on said provider database with Federal Income Tax database.

12. An operational computing network for tracking a user of an exemption law as recited in claim 7, said operational computing network comprising:
said provider display screen displaying results of comparing a list of individual addresses on said provider database with license plate database.

13. An operational computing network for tracking a user of an exemption law, said operational computing network comprising:
a provider microprocessor;
a homestead software program including an algorithm;
a provider database;
a provider display screen;
a voter registration database;
a department of motor vehicles database;
a user identifier code;
means for calculating a score for each user based on address mismatches, license expiration dates, last voted dates and tax payment dates; and
means for preparing a report based on said score.

14. An operational computing network for tracking a user of an exemption law as recited in claim 13, said operational computing network comprising:
said provider display screen displaying results of comparing a list of individual addresses on said provider database with said voter registration database.

15. An operational computing network for tracking a user of an exemption law as recited in claim 13, said operational computing network comprising:
said provider display screen displaying results of comparing a list of individual addresses on said provider database with said motor vehicles database.

16. An operational computing network for tracking a user of an exemption law as recited in claim 13, said operational computing network comprising:
said provider display screen displaying results of comparing a list of individual addresses on said provider database with a real estate tax database.

17. An operational computing network for tracking a user of an exemption law as recited in claim 13, said operational computing network comprising:
said provider display screen displaying results of comparing a list of individual addresses on said provider database with Federal Income Tax database.

18. An operational computing network for tracking a user of an exemption law as recited in claim 13, said operational computing network comprising:
said provider display screen displaying results of comparing a list of individual addresses on said provider database with license plate database.

19. An operational computing network for tracking a user of an exemption law as recited in claim 13, said operational computing network comprising:
an algorithm for calculating an HEV score for each user.
